(19) United States
(12) Patent Application Publication
(10) Pub. No.: US 2026/0249195 A1
(43) Pub. Date: Aug. 27, 2026

(54) THIRD PARTY ENABLEMENT OF GAME FEATURES

(71) Applicant: Coapperate, LLC, Sarasota, FL (US)

(72) Inventor: Michael Wyckoff, Sarasota, FL (US)

(21) Appl. No.: 19/061,795

(22) Filed: Feb. 24, 2025

Related U.S. Application Data
(63) Continuation-in-part of application No. 18/593,542, filed on Mar. 1, 2024, now abandoned.
(60) Provisional application No. 63/487,889, filed on Mar. 2, 2023.

(51) Int. Cl. A63F 13/69; A63F 13/792

(52) U.S. Cl. CPC A63F 13/69; A63F 13/792

(57) ABSTRACT

Third party enablement of game features for a game on a mobile device is described. An award provider service receives an indication of one or more candidate game features from a game server. The award provider service notifies an application of the availability of a game feature the candidate game features and associates game feature enablement criteria with the game feature(s). The award provider service receives an enrollment request to enroll a user application and a game application. The user application may be hosted on a first mobile device and the game application may be hosted on a second mobile device. Alternatively, the user application and the game application may be hosted on the same mobile device. The user application is used to satisfy the game feature enablement criteria. Upon satisfaction of the game feature enablement criteria, the game feature for the game application is enabled.

### TECHNICAL FIELD

The claimed subject matter relates to the field of game applications on mobile devices.

### BACKGROUND

This background description is provided for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Mobile gaming applications (“apps”) have become one of the most popular forms of entertainment worldwide, offering a diverse range of experiences from casual puzzle games to complex multiplayer strategy games. Their accessibility on smartphones and tablets, combined with free-to-play models and in-app purchases, led to the widespread adoption of mobile gaming applications across all age groups. Advances in mobile technology, such as high-performance processors and 5G connectivity, have enabled features such as augmented reality (AR) and cloud-based gaming. In order to maintain interest in a particular mobile gaming application, a developer may add new features and game mechanics that are intended to enhance user engagement with the mobile gaming application.

### BRIEF SUMMARY

The systems, methods, and apparatuses of this disclosure each have several innovative aspects, no single one of which is solely responsible for the desirable attributes disclosed herein.

In one innovative aspect, an apparatus includes one or more processors. The apparatus also includes an award provider service executed by the one or more processors, the award provider service configured to: provide, to a client application, data defining one or more game features corresponding to a game application, the data including, for each of the one or more game features, detect feature enablement criteria, receive, from the client application, a first indicator indicating that the feature enablement criteria corresponding to the game feature has been satisfied, and in response to receipt of the first indicator, enable, for the game application, the game feature corresponding to the feature enablement criteria.

In another innovative aspect, a device includes one or more processors. The device also includes a client application executed by the one or more processors, the client application configured to: receive, from an award provider service, data defining one or more game features corresponding to a game application, the data including, for each of the one or more game features, feature enablement criteria, and provide, to the award service application, a first indicator indicating that the feature enablement criteria corresponding to the game feature has been satisfied.

Details of one or more implementations of the subject matter described in this disclosure are set forth in the accompanying drawings and the description below. Other features, aspects, and advantages will become apparent from the description, the drawings, and the claims. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the claimed subject matter. The claimed subject matter is not limited to the precise arrangements and instrumentalities shown.

Like reference numbers and designations in the various drawings indicate like elements. Note that the relative dimensions of the figures may not be drawn to scale. To easily identify the discussion of any particular element or act, the most significant digit or digits in a reference number typically refer to the figure number in which that element is first introduced.

FIG. 1 is a block diagram illustrating a networked system for third party enablement of game features.

FIG. 2A is a communication flow diagram showing an example of a third party user application detecting satisfaction of game feature enablement criteria and an award service provider enabling the game feature.

FIG. 2B is a communication flow diagram showing an example of a third party user application detecting satisfaction of game feature enablement criteria and a game service enabling the game feature.

FIG. 2C is a communication flow diagram showing an example of an award service provider detecting satisfaction of game feature enablement criteria and the award service provider enabling the game feature.

FIG. 2D is a communication flow diagram showing an example of an award service provider detecting satisfaction of game feature enablement criteria and a game service enabling the game feature.

FIG. 3A is a communication flow diagram showing a first example of enrolling a game application for third party feature enablement.

FIG. 3B is a communication flow diagram showing a second example of enrolling a game application for third party feature enablement.

FIG. 3C is a communication flow diagram showing a third example of enrolling a game application for third party feature enablement.

FIG. 3D is a communication flow diagram showing a fourth example of enrolling a game application for third party feature enablement.

FIG. 4A is a flow chart diagram illustrating example award provider service operations of a method for third party game feature enablement.

FIG. 4B is a flow chart diagram illustrating example user application operations of a method for third party game feature enablement.

FIG. 5 is a block diagram illustrating the network architecture of a system for increasing retail sales of goods and services over a communications network, in accordance with one embodiment.

FIG. 6A is a communication flow diagram showing the data flow of the process for increasing retail sales of goods and services over a communications network, according to a first embodiment.

FIG. 6B is a communication flow diagram showing the data flow of the process for increasing retail sales of goods and services over a communications network, according to a second embodiment.

FIG. 7A illustrates an aspect of the subject matter in accordance with one embodiment.

FIG. 7B illustrates an aspect of the subject matter in accordance with one embodiment.

FIG. 8 is a block diagram depicting a system including an example computing device and other computing devices.

### DETAILED DESCRIPTION

In the following detailed description of embodiments of the present disclosure, reference is made to the accompanying drawing figures in which like references indicate similar elements, and in which is shown by way of illustration specific embodiments in which the present disclosure may be practiced. These embodiments are described in sufficient detail to enable those skilled in the art to practice the present disclosure, and it is to be understood that other embodiments may be utilized and that logical, mechanical, electrical, functional, and other changes may be made without departing from the scope of the present disclosure. The following detailed description is, therefore, not to be taken in a limiting sense, and the scope of the present disclosure is defined only by the appended claims.

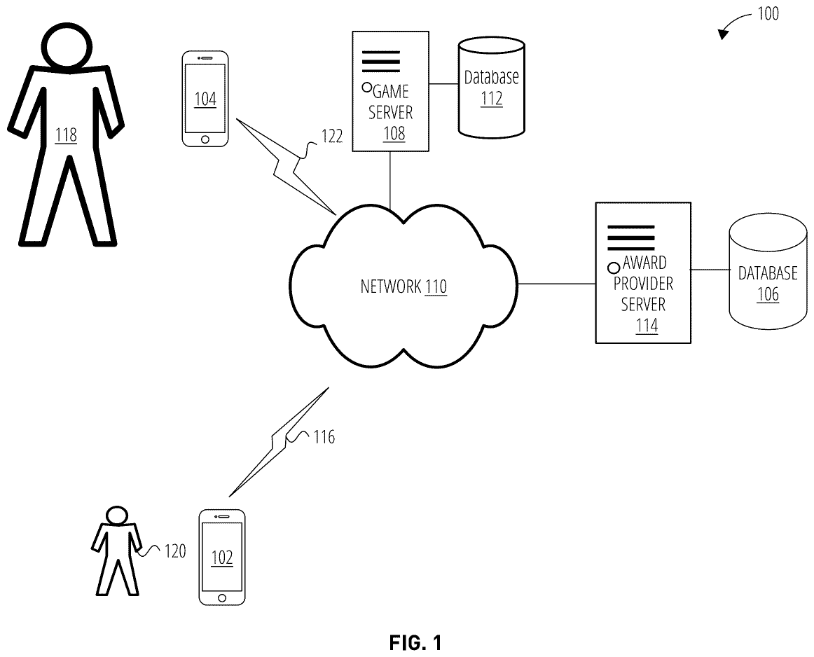

FIG. 1 is a block diagram illustrating a networked system 100 for third party enablement of game features. In the example shown in FIG. 1, the networked system 100 includes a mobile device 102 utilized by user 120 (also referred to as a “player”) and a mobile device 104 utilized by user 118. In some examples, the mobile device 102 and/or mobile device 104 may be a smartphone, mobile phone, tablet computer, handheld computer, laptop computer, or the like. In other examples, mobile device 102 and/or mobile device 104 may be workstations, desktop computers, servers, all-in-one computers, or the like. In some examples, mobile device 102 and/or mobile device 104 may be augmented reality (AR) or virtual reality (VR) systems that may include display screens, headsets, heads-up displays, helmet mounted display screens, tracking devices, or the like. The mobile device 102 and mobile device 104 may execute a gaming application. In other embodiments, the mobile device 102 and mobile device 104 may execute a user application (also referred to as a “client application”) such as a health and fitness application, music application, entertainment application, social networking application, work application, business application, retail application, e-commerce application, a product or service purchase application, a retailer loyalty application, a credit acquisition application, an enablement criteria application, a sales application, or any application for other purposes. In some aspects, the user application may be a browser extension.

FIG. 1 also shows game server 108 and award provider server 114, which may be workstations, servers, or the like. Mobile device 102 and mobile device 104 may be communicatively coupled with network 110 via wired communications links (e.g., wireless links 122 and 116) and/or wired communications links. User 118 may be the same person as user 120 or a different person, and mobile device 102 may be the same device as mobile device 104 or a different device.

FIG. 1 further shows that game server 108 includes a database 112, which may be a cloud database stored in the cloud. Mobile device 102 and mobile device 104 may each include their own database. The database 112 is a repository for data used by game server 108 (and possibly mobile device 102 and/or mobile device 104) during the course of operation of the disclosed embodiments. Database 112 may be distributed over one or more nodes or locations that are connected via network 110.

The database 112 may include player account information for each game user 120 (and/or user 118). The player account information may include one or more of: a user identifier uniquely identifying a game user or game account, a password for the game user or game account, contact/identifying information for the user (name, address, telephone number(s), email address, etc.), a current location of each user (based on location-based services from the user's mobile computer) and the like.

The database 112 may include data describing one or more game features. A game feature may be a credit, a gameplay feature, additional or enhanced character attributes (e.g., health, abilities, powers or skills), a skin, an avatar, unlocking levels, game currency, additional game mechanics, additional lives or turns, additional or enhanced game objects (e.g., weapons, tools, food, supplies, clothing, and the like) or any other feature that adds to a game application resident on mobile device 102.

FIG. 1 shows an embodiment wherein mobile devices 102 and 104 interact with a game server 108 and database 112 over network 110. It should be noted that although FIG. 1 shows only mobile device 102 and mobile device 104, the system of the disclosed embodiments supports any number of networked computing devices connected via network 110. Game server 108 may host a game application service configured to perform the operations described herein for game server 108.

Although game server 108 is shown as a single and independent entity, in some aspects, the functions of game server 108 may be integrated with another entity, such as one of the mobile device 102 or mobile device 104. Further, game server 108 and its functionality, according to some aspects, can be realized in a centralized fashion in one computer system or in a distributed fashion wherein different elements are spread across several interconnected computer systems.

FIG. 1 also shows an award provider server 114. The award provider server 114 in some aspects can be owned, operated, and/or managed by an enterprise. In some aspects, the enterprise may be a charitable or fraternal organization, a governmental entity, or a business.

The award provider server may host an award provider service configured to perform the operations described herein for the award provider server 114. Database 106 maintains information about gaming features that can be awarded for use on a game application that is executed on mobile device 102. In some aspects, the game features may be obtained, for example, from game server 108. Database 106 can maintain feature enablement criteria associated with a game feature. Such feature enablement criteria may comprise one or more of a purchase amount, a purchase of at least one of the one or more items or services, or an indication that a client device is located in proximity to at least one of the one or more offer locations. An offer location may be a location associated with the enterprise. For example, in the case of a charitable or fraternal enterprise, the offer location may be a charity event or meeting place. In the case of a governmental organization, the offer location may be a national, state, or local park and the like. In the case of a business enterprise, the offer location may be a retail location associated with the business enterprise. A game feature may be associated in database 106 with one or more user qualification criteria, one or more items or services, or one or more offer locations.

In some aspects, database 106 may maintain account data describing a client application account, for example a client application account associated with user 118. Such data may include one or more of a user identifier uniquely identifying the client application account (e.g., a loyalty account and/or ordering account), a password for the client application account, contact/identifying information for the user (name, address, telephone number(s), email address, etc.), a current location of each user (based on location-based services from the user's mobile computer) and a description of past goods/services purchased or ordered by each user. The account data may further include demographic data for each user, such as age, sex, income data, race, color, marital status, etc. The account data may also include contact information (email address, name, address, telephone number, etc.) or a unique identifier for one or more friends or acquaintances of the user. The account data may also include a user credit, which is a credit that is used by a consumer while using an application, such as while using a video game during gameplay. Said credit can be used to purchase or receive virtual goods, real goods, virtual services, real services, etc. Credit refers to any medium of exchange, which can include digital currency, purchase cards, gift cards, player credits, points, etc. Credit may also refer to features, functionality or a virtual good itself, such as a skin, an avatar, a virtual good, etc., information pertaining to credits associated with the user, contact/identifying information for friends of the user, electronic payment information for the user, information pertaining to the purchases made by the user, sales transaction data associated with the user, etc.

The user 120 and user 118 may enroll and register with game server 108 and/or award provider server 114 to create a player account and/or client application account, respectively. In the course of enrolling or registering, the users may enter data into their device by manually or automatically entering data into a mobile application via keypad, touchpad, or via voice or other means. In the course of enrolling or registering, the users may enter any data that may be stored in a player account or user account as defined above. Also in the course of enrolling or registering, the game server 108 and/or award provider server 114 may generate account data for each registering user and store the account data in an attached database, such as database 112 or database 106.

Game server 108, award provider server 114, mobile device 102 and mobile device 104 include program logic such as computer programs, mobile applications, executable files or computer instructions (including computer source code, scripting language code or interpreted language code that may be compiled to produce an executable file or that may be interpreted at run-time) that perform various functions of the techniques described herein.

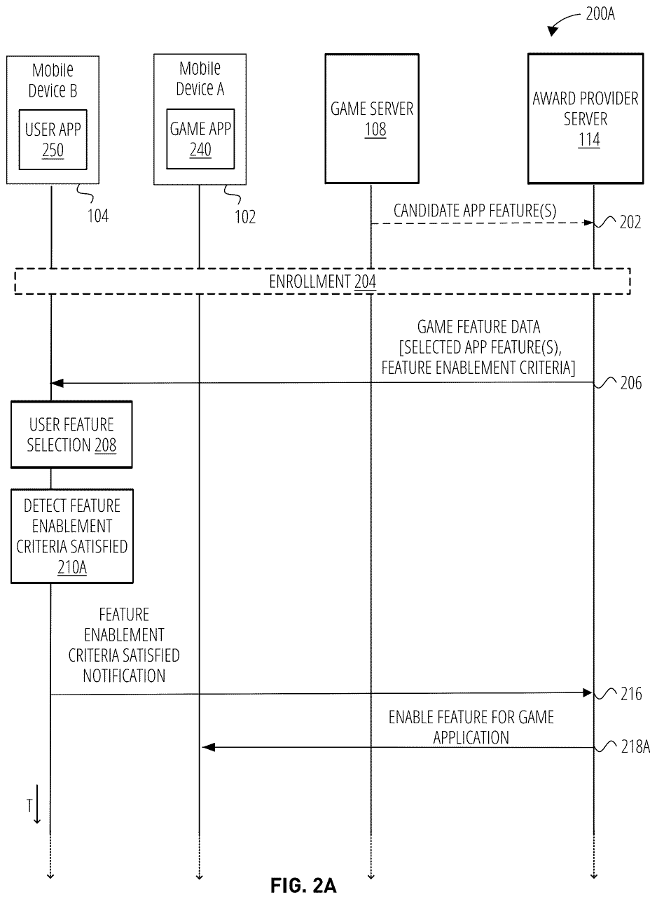

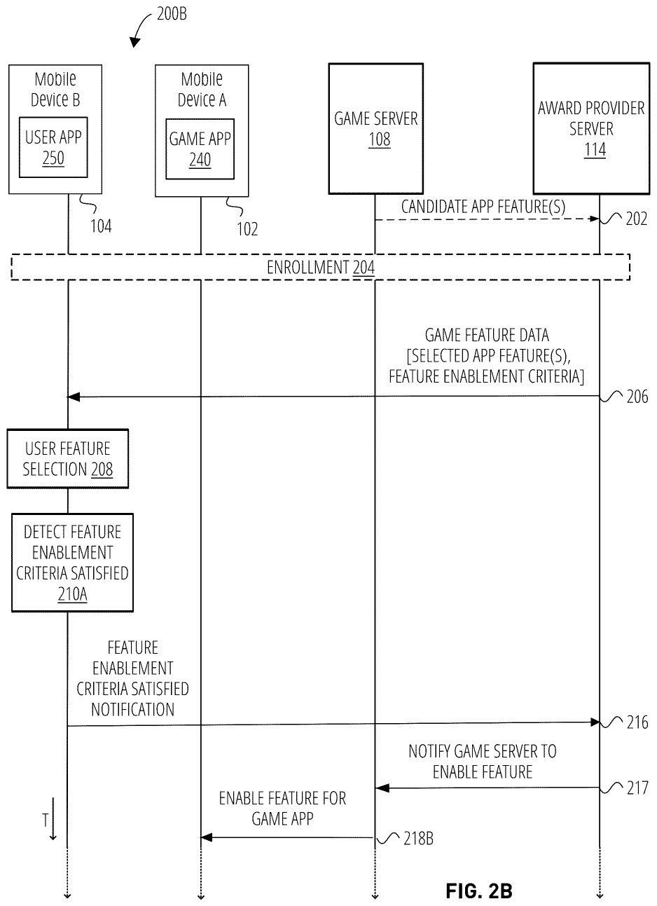

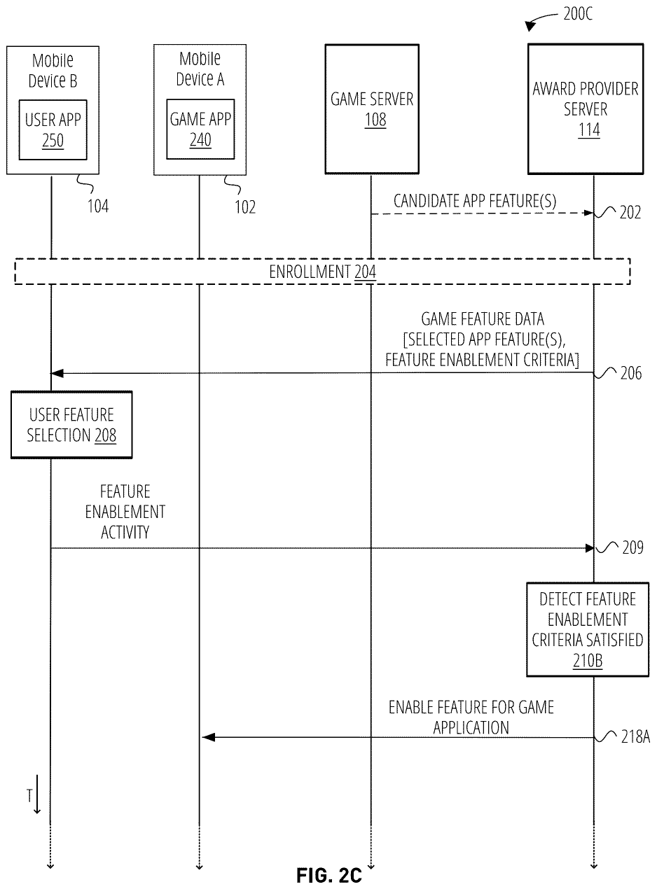

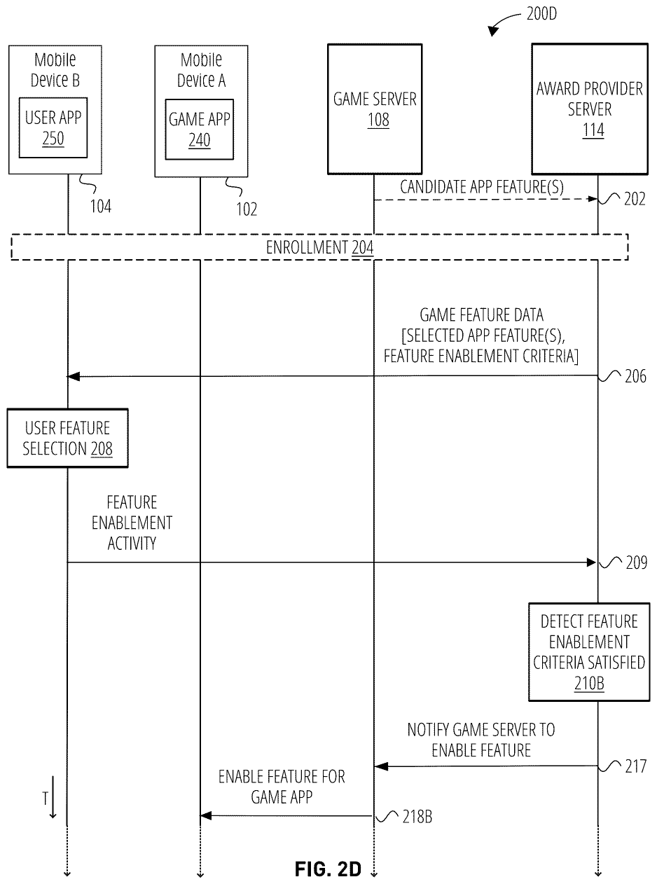

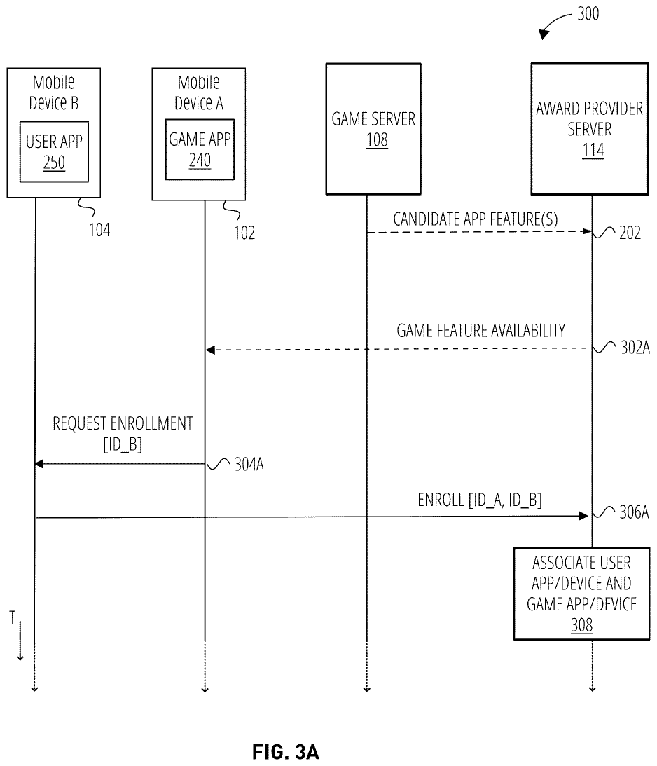

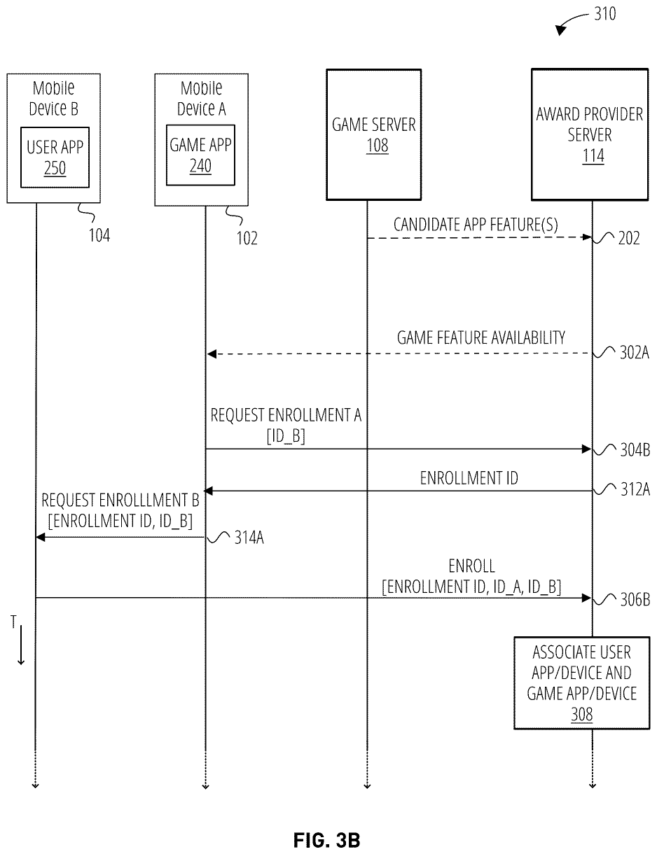

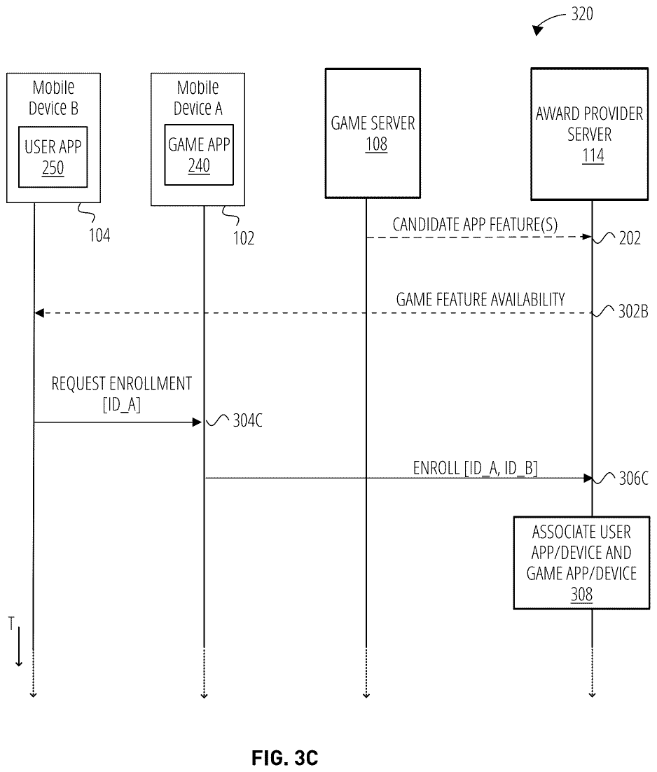

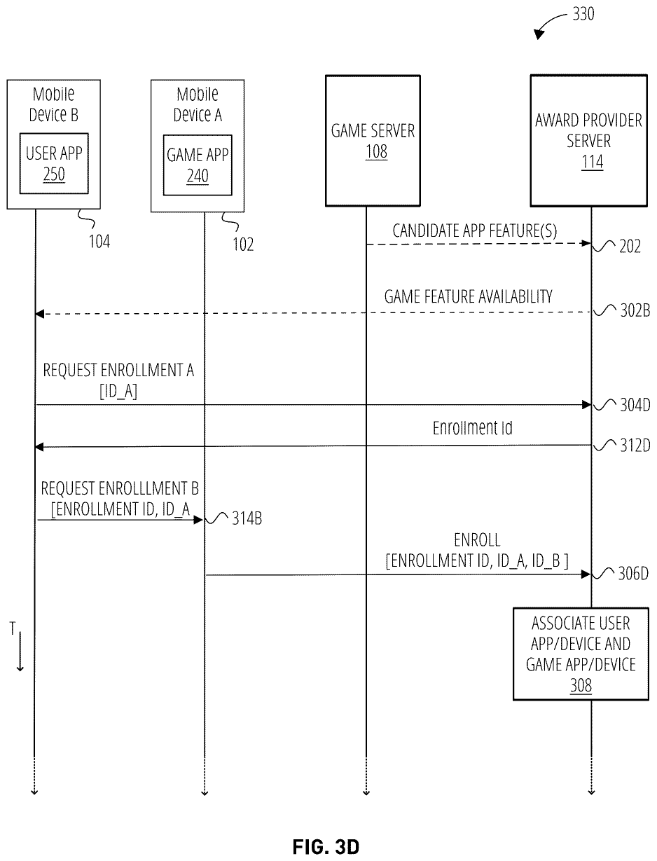

Techniques for third party enablement of game features for a user of a mobile device (e.g., mobile device 102 will now be described with reference to FIG. 2A, FIG. 2B, FIG. 3A and FIG. 3B below. FIG. 2A and FIG. 3A depict the data flow and control flow of a process for third party enablement of game features for a user of a mobile device 102 over a communications network according to a first embodiment. FIG. 2B and FIG. 3B depict the data flow and control flow of the process of third party enablement of game features for a user of a mobile device 102, according to a second embodiment. Dotted lines indicate optional operations.

FIG. 2A is a communication flow diagram 200A showing an example of a third party user application detecting satisfaction of game feature enablement criteria and an award service provider enabling the game feature.

At operation 202, the game server 108 transmits one or more candidate game application features to the award provider server 114. The award provider server receives a selection of one or more of the candidate game features from an user or administrator for inclusion in an offer that the award service provide can transmit to user application 250 or game application 240 for presentation to users (e.g., user 118) and/or game players (e.g., user 120).

At block 204, user application 250 and/or game application 240 may be used to enroll for third party game feature enablement. For example, a user 118 (FIG. 1) may utilize user application 250 to enroll for third party game feature enablement. Similarly, user 120 may utilize game application 240 to enroll for third party game feature enablement. Further details on enrollment techniques are provided below with respect to FIG. 3A through FIG. 3D.

At operation 206, the award provider server 114 transmits data that defines the offer (“offer data”) to the user application 250. The offer data may specify one or more of the selected game features for the offer that are pertinent to the game application 240 and specify feature enablement criteria for each of the one or more game features included in the offer. In some aspects, the offer data may include or indicate user interface (UI) elements identifying the game features in the offer. This data defines how the one or more game features in the offer are displayed on the mobile device 102 or mobile device 104. Examples of such user interface elements include logos, symbols, position information for the user interface, selection user interface elements for selecting the game feature, and/or code for modifying the user application 250 to display the user interface elements. The user 120 or user 118 (with reference to FIG. 1) may select one or more game features from among the presented options using the UI.

At block 208, the user application 250 receives a selection of a game feature of the one or more game features. In response to the selection, in some aspects, the user application 250 can begin to monitor for satisfaction of the feature enablement criteria associated with the selected game feature. For example, if the feature enablement criteria is the purchase of a specified item via the user application 250, then the user application 250 can monitor for the purchase of the item. As another example, if the feature enablement criteria is the purchase of a threshold amount of goods and/or services, the user application 250 can track purchases made via the user application 250 and monitor for the purchase amount exceeding the threshold. As a further example, if the feature enablement criteria is that the user 118 must go to a location (e.g., a particular store or group of stores, a park, an event, etc.), then the user application 250 can monitor the location of the mobile device 104 to determine if the device is at the location specified in the feature enablement criteria.

At block 210A, the user application 250 detects that the feature enablement criteria has been satisfied.

At operation 216, the user application 250 transmits a notification message to the award service provider indicating that the feature enablement criteria for the game feature has been satisfied.

At operation 218A, the award service provider transmits a message to the game application enabling the game feature for the game application. In some aspects, the message may include an indicator or code that enables or unlocks the game feature. In some aspects, the message may include code, scripts, or other executable instructions that implement some or all of the game feature.

FIG. 2B is a communication flow diagram 200B showing an example of a third party user application detecting satisfaction of game feature enablement criteria and a game service enabling the game feature. The example of FIG. 2B is similar the example of FIG. 2A discussed above. For example, operation 202, block 204, operation 206, block 208, block 210A, and operation 216 of FIG. 2B have been described above with respect to FIG. 2A and will not be further described here. The difference between the two examples is in how the game feature is enabled.

At operation 217, the award provider server 114 transmits a message to the game server 108 indicating that the game server 108 should enable the game feature. In some aspects, at operation 218B, the game server transmits a message to the game application 240 enabling the game feature for the game application. As was the case in the example of FIG. 2A, the message may include an indicator or code that enables or unlocks the game feature. In some aspects, the message may include code, scripts, or other executable instructions that implement some or all of the game feature. In some aspects, some or all of the game feature may be implemented on the game server. In such aspects, the game server enables the game feature for the game account associated with the game application 240.

Although FIG. 2A and FIG. 2B show the game application 240 and the user application 250 residing on different mobile devices 102 and 104, respectively, in some aspects, the game application 240 and the user application 250 may reside on the same mobile device. In some aspects, the award provider server may include a first application program interface (API) configured to receive the data defining the candidate game features (e.g., at operation 202) and a second API to receive the notification that the feature enablement criteria has been satisfied (e.g., at operation 216.

FIG. 2C is a communication flow diagram 200C showing an example of an award service provider detecting satisfaction of game feature enablement criteria and the award service provider enabling the game feature. The example of FIG. 2C is similar to the example of FIG. 2A discussed above. For example, operation 202, block 204, operation 206, block 208, and operation 218A of FIG. 2A have been described above with respect to FIG. 2A and will not be further described here. The difference between the two examples is that the award provider server 114 detects that the feature enablement criteria has been satisfied instead of the user application 250.

In the example of FIG. 2C, at operation 209, the user application 250 transmits one or more indications or data related to the feature enablement criteria. As an example, if the feature enablement criteria relates to the location of the mobile device, the user application 250 may transmit location data of the mobile device to the award provider server 114 at operation 209.

As another example, if the feature enablement criteria relates to the purchase of one or more items or services, at operation 209, the user application 250 may transmit an indication that the one or more items or services have been purchased to the award provider server 114.

The user application 250 may facilitate the purchase of the item or service. In some aspects, the purchase may be for a single item or amount. In some other aspects, the feature enablement criteria may be associated with the purchase of multiple items (perhaps over a predefined or configurable time period) or the purchase of multiple items over a consecutive number of days. In some other aspects, the feature enablement criteria may be related to the purchase of a specified combination of items or services (again, perhaps within a time period). The award service award provider server 114 may track the purchases over time if multiple purchases are part of the game feature enablement criteria. In this example, the award provider server 114 may be a retailer e-commerce server associated with a retailer or may otherwise be associated with a retailer.

As another example, the feature enablement criteria may be associated with a code.

For example, a code may be displayed at an event such as a charity event, a sporting event or exhibition. Similarly, a code may be broadcast over media such as radio, television, streaming media and the like. The user may input the code in the user application via a keyboard interface, camera or other input device of the mobile device hosting the user application. The user application may transmit the code to the award provider server 114 as part of the data transmitted at operation 209.

At block 210B, the award provider server 114 detects that the feature enablement criteria have been satisfied, for example, by comparing data received at operation 209 with the game feature enablement criteria.

Continuing the example of feature enablement criteria that is related to the location of the mobile device hosting the user application, the award provider server 114 may determine whether or not the mobile device is in a location that satisfies the feature enablement criteria based on location data transmitted at operation 209. For example, the feature enablement criteria may include a requirement that the user of the mobile device hosting the user application 250 visit a particular location (e.g., park, museum, store, theater, etc.) If the location data received at operation 209 matches the location specified by the feature enablement criteria, the award provider server 114 may determine that the feature enablement criteria has been satisfied.

Continuing the example of game feature enablement criteria related to purchases, the award provider server 114 may, at block 210B, detect that the purchase data transmitted at operation 209 meets the game feature enablement criteria. As noted above, the award provider server 114 may track the purchases over time to detect if the game feature enablement criteria have been met.

Continuing the example of game feature enablement criteria that is related to a code that is displayed at an event or via media, the award provider server 114 may detect that the game feature enablement criteria has been satisfied when the award provider server 114 receives a code at operation 209 that matches a code enabling the game feature.

In some aspects, the feature enablement criteria may have a time aspect. For example, the feature enablement criteria may be associated with a holiday, the user's birthday, wedding anniversary, amount of time since the user application was downloaded, installed, activated, or associated with a user account, and the like. Similarly, the feature enablement criteria may be associated with certain milestone events such as graduation from a school, college, or university, completion of a program, academic achievement, and the like.

In some aspects, the award provider server 114 may obtain data externally to the user application to detect that the game feature enablement criteria has been satisfied. For example, the user application may, at operation 209, transmit data to be used to indicate a preferred sports team or other organization. The award provider server 114 may obtain data from an external server or service (not shown in FIG. 2C) indicating whether the preferred sports team won a recent game or series of games, or achieved a certain win/loss record, among other criteria.

FIG. 2D is a communication flow diagram 200D showing an example of an award service provider detecting satisfaction of game feature enablement criteria and a game service enabling the game feature. The example of FIG. 2D is similar to the example of FIG. 2B discussed above. For example, operation 202, block 204, operation 206, block 208, operation 217 and operation 218B have been described above with respect to FIG. 2B and will not be further described here. The difference between the two examples is that the award provider server 114 detects that the feature enablement criteria has been satisfied instead of the user application 250.

Like the example shown in FIG. 2C, in the example of FIG. 2D, at operation 209, the user application 250 transmits one or more indications related to the game feature enablement criteria.

At block 210B, the award provider server 114 detects that the feature enablement criteria have been satisfied.

FIG. 3A to FIG. 3D are communication flow diagrams illustrating various aspects of enrolling a device for third party enablement of game features. The discussion below refers to identifiers such as device identifiers, application identifiers, account identifiers, and the like.

Such identifiers are used to uniquely identify a device, application, or user for use in third party enablement of game features. In some aspects, the identifier be one or more of: an IMEI (International Mobile Equipment Identity, MAC (Media Access Control) address, Android ID, a UUID (Universally Unique Identifier) generated by the user application or game application when the application is installed or when enrolment is requested, an email address, a username, a phone number, and the like. FIG. 3A to FIG. 3D and the corresponding discussion below use “ID A” to refer to an identifier associated with mobile device A (e.g., mobile device 102) and “ID B” to refer to an identifier associated with mobile device B (e.g., mobile device 104).

In each of FIG. 3A to FIG. 3D, the communication flow begins with operation 202 where the award provider server 114 receives candidate game features as discussed above with respect to FIG. 2A.

FIG. 3A is a communication flow diagram 300 showing a first example of enrolling a game application for third party feature enablement. At operation 302A, the award provider server 114 optionally transmits a notification of game feature availability to game application 240. As an example, the award provider server may transmit a message, quick response (QR) code, or other notification that notifies the player that a game feature is available, and may provide information on how to obtain the game features.

In some aspects, a player may be notified of the availability of a game feature via an advertisement of the game feature. The advertisement may be part of advertising associated with a product or service provided by an enterprise. The notification may comprise a QR code, a URL (Uniform Resource Locator) or other indicator of a source to receive information on the game feature and how to obtain the game feature.

At operation 304A, the game application 240 transmits a request to enroll for the game feature to mobile device 104. In some aspects, the request to enroll may be a message such as a text message. In some aspects, the request to enroll may be a message sent to user application 250, which may then display a notification that the game application 240 is requesting that the user of mobile device 104 (e.g., user 118) take action to enroll the game application and the user application for third part enablement of game features for the game application 240. The message may include ID_B associated with the game application.

At operation 306A, the mobile device 104 transmits an enroll message to the award provider server. In some aspects, the enroll message may include ID_A associated with the user application and ID_B associated with the game application.

At block 308, the award provider server 114 associates the user application/device and game application/device by associating ID_A and ID_B with one another, for example, in database 106 (FIG. 1). The ID_A and ID_B may also be associated with the game feature and/or the game feature enablement criteria.

As stated above, a first user 120 may be the same or different as a second user 118, and a first mobile device 102 may be the same or may be different as a second mobile device 104.

FIG. 3B is a communication flow diagram 310 showing a second example of enrolling a game application for third party feature enablement. The example of FIG. 3B is similar to the example of FIG. 3A with a difference being that in FIG. 3B, the game application 240 transmits the request enrollment message to the award provider server 114 instead of transmitting the request enrollment message to the mobile device 104.

At operation 304B, the game application 240 transmits a message to request enrollment to the award provider server 114. In some aspects, the message may include ID_B identifying the game application 240.

At operation 312A, the award provider server 114 transmits an enrollment ID to the game application 240. The enrollment ID can be a unique identifier for the enrollment request. In some aspects, the award provider server 114 associates the enrollment ID with the ID_B, for example, in database 106 (FIG. 1).

At operation 314A, the game application 240 transmits the enrollment ID to the mobile device 102A along with its ID_B.

At operation 306B, the user application 250 transmits an enroll message including the enrollment ID, ID_A, and ID_B to the award provider server 114.

At block 308, the award provider server 114 associates the user application/device and game application/device by associating ID_A and ID_B with one another, for example, in database 106 (FIG. 1). The ID_A and ID_B may also be associated with the game feature and/or the game feature enablement criteria.

FIG. 3C is a communication flow diagram 320 showing a third example of enrolling a game application for third party feature enablement. The example of FIG. 3C differs from the examples of FIG. 3A and FIG. 3B in that the game feature availability is initially provided to the user application 250 instead of the game application 240.

At operation 302B, the award provider server 114 optionally transmits a notification of game feature availability to user application 250. As an example, the award provider server 114 may transmit a message, QR code, or other notification that notifies the user of application 250 that a game feature is available, and may provide information on how to obtain the game features.

Like the examples of FIG. 3A and FIG. 3B, in some aspects, a user may be notified of the availability of a game feature via an advertisement of the game feature. The advertisement may be part of advertising associated with a product or service provided by an enterprise. The notification may include an encoded image such as a QR code, a URL (Uniform Resource Locator), or other indicator of a source to receive information on the game feature and how to obtain the game feature.

At operation 304C, the user application 250 transmits a request to enroll for the game feature to mobile device 102. In some aspects, the request to enroll may be a message such as a text message. In some aspects, the request to enroll may be a message sent to game application 240, which may then display a notification that the user application 250 is requesting that the user of mobile device 102 (e.g., user 120) take action to enroll the game application 240and the user application 250 for third party enablement of game features for the game application 240. The message may include ID_A associated with the user application 250.

At operation 306C, the game application 240 transmits an enroll message to the award provider server 114. In some aspects, the enroll message may include ID_A associated with the user application and ID_B associated with the game application.

At block 308, the award provider server 114 associates the user application/device and game application/device by associating ID_A and ID_B with one another, for example, in database 106 (FIG. 1). The ID_A and ID_B may also be associated with the game feature and/or the game feature enablement criteria.

FIG. 3D is a communication flow diagram 330 showing a fourth example of enrolling a game application for third party feature enablement. The example of FIG. 3D is similar to the example of FIG. 3C with the difference being that in FIG. 3D, the user application 250 transmits the request enrollment message to the award provider server 114 service instead of transmitting the request enrollment message to the mobile device 102.

At operation 302B, the award provider server 114 optionally transmits a notification of game feature availability to user application 250.

At operation 304D, the user application 250 transmits a message to request enrollment to the award provider server 114. In some aspects, the message may include ID_A identifying the user application 250.

At operation 312D, the award provider server 114 transmits an enrollment ID to the user application 250. The enrollment ID can be a unique identifier for the enrollment request. In some aspects, the award provider server 114 associates the enrollment ID with the ID_A, for example, in database 106 (FIG. 1).

At operation 314B, the user application 250 transmits the enrollment ID to the mobile device 102 along with its ID_A.

At operation 306D, the game application 240 transmits an enroll message including the enrollment ID, ID_A, and ID_B to the award provider server 114.

At block 308, the award provider server 114 associates the user application/device and game application/device by associating ID_A and ID_B with one another, for example, in database 106 (FIG. 1). The ID_A and ID_B may also be associated with the game feature and/or the game feature enablement criteria.

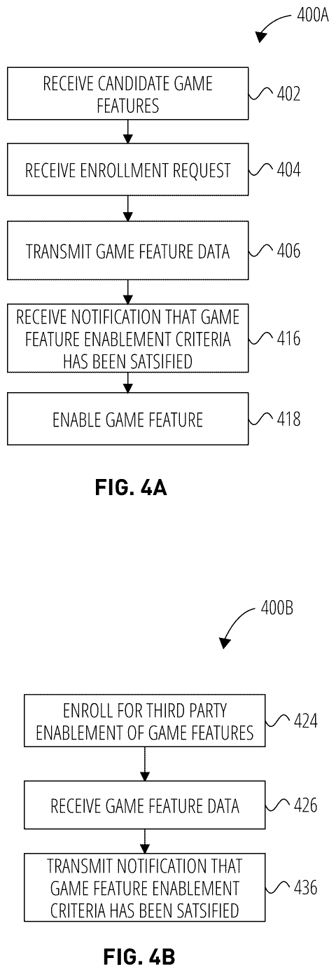

FIG. 4A is a flow chart diagram 400A illustrating example award provider service operations of a method for third party game feature enablement. The operations of FIG. 4A may be performed, for example, by the award provider server 114 of FIG. 1 through FIG. 3D.

At block 402, and as described above with respect to FIG. 2A and FIG. 2B, operation 202, the award provider server receives one or more candidate game application features. The award provider server receives a selection of one or more of the candidate game features from a user or administrator for inclusion in an offer that the award provider server 114 can present transmit to a user application or game application.

At block 404, and as described above with respect to FIG. 2A and FIG. 2B, block 204, the award provider server receives an enrollment request from a user application or game application. Further details on enrollment techniques have been provided above with respect to FIG. 3A through FIG. 3D.

At block 406, and as described above with respect to FIG. 2A and FIG. 2B, operation 206, the award provider server transmits data that defines an offer (“offer data”) to a user application (e.g., user application 250 of FIG. 2A and FIG. 2B).

At block 416, and as further described above with respect to FIG. 2A and FIG. 2B, operation 216, the award provider server receives a notification message provider indicating that the feature enablement criteria for the game feature has been satisfied.

At block 418, and as further described above with respect to FIG. 2A, operation 218A, the award service provider transmits a message to the game application enabling the game feature for the game application. In some aspects, the message may include an indicator or code that enables or unlocks the game feature. In some aspects, the message may include code, scripts, or other executable instructions that implement some or all of the game features.

FIG. 4B is a flow chart diagram 400B illustrating example user application operations of a method for third party game feature enablement. The operations of FIG. 4B may be performed, for example, by the user application 250 of FIG. 2A to FIG. 2B.

At block 424, and as described above with respect to FIG. 2A and FIG. 2B, block 204, the user application optionally transmits an enrollment request to an award provider server (e.g., award provider server 114 of FIG. 1, FIG. 2A, and FIG. 2B. As noted above, the enrollment request may be provided by a game application (e.g., game application 240) instead of, or in addition to, the user application. Further details on enrollment techniques have been provided above with respect to FIG. 3A through FIG. 3D.

At block 426, and as described above with respect to FIG. 2A and FIG. 2B, operation 206, the user application receives data that defines an offer (“offer data”) from the award provider server.

Blocks 208 and 210A have been described above with respect to FIG. 2A, and are not further described here.

At block 436, and as described above with respect to FIG. 2A, operation 216, the user application transmits a notification message to the award service provider indicating that the feature enablement criteria for the game feature has been satisfied.

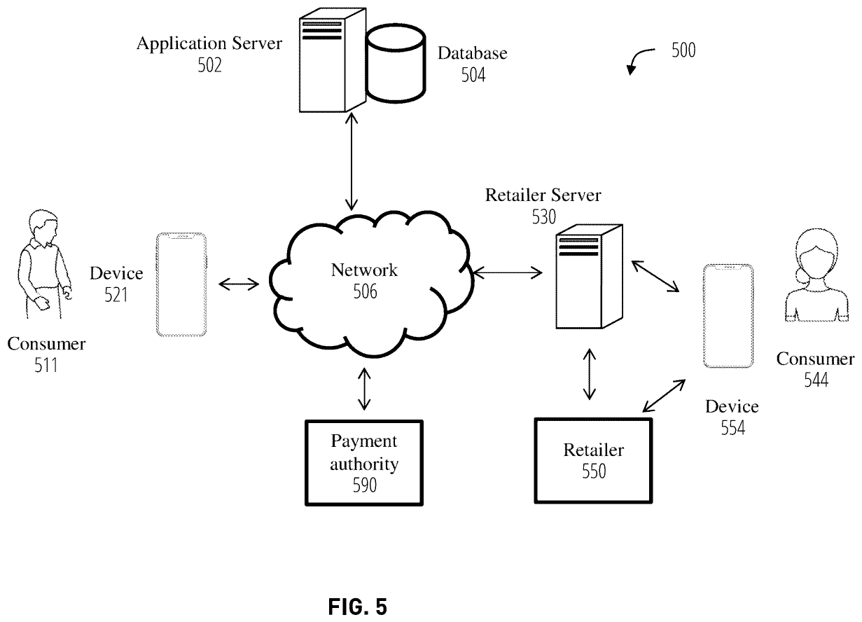

Additional embodiments for providing application features will now be described with respect to FIG. 5 to FIG. 7B.

FIG. 5 includes mobile computing device 521 utilized by user or consumer 511 and computing device 554 utilized by user or consumer 544 which may be smart phones, mobile phones, tablet computers, handheld computers, laptops, or the like. In another embodiment, mobile computing device 521 and 554 may be workstations, desktop computers, servers, laptops, all-in-one computers, or the like. In another embodiment, mobile computing device 521 and 554 may be augmented reality (AR) or virtual reality (VR) systems that may include display screens, headsets, heads-up displays, helmet mounted display screens, tracking devices, or the like. The client computing devices 521 and 554 may execute a client application such as a mobile gaming application or any other application. In other embodiments, the client application may be a gaming application, health and fitness application, music application, entertainment application, social networking application, work application, business application, retail application, e-commerce application, or any application for other purposes. In another embodiment, the client computing devices 521 and/or 554 may execute a client application such as a retail application, a product or service purchase application, a retailer application, a credit acquisition application, an enablement criteria application, a sales application, or the like.

FIG. 5 also shows servers 502, 530, which may be workstations, servers, or the like.

Devices 521, 554, 502, and 530 may be communicatively coupled with network 506 in a wired or wireless fashion. FIG. 5 also shows a consumer 544, which may be the same person as consumer 511 or a different person. FIG. 5 also shows consumer 511 and consumer 544, who may be using the same device.

FIG. 5 further shows that server 502 includes a database or repository 504, which may be a cloud database stored in the cloud. Devices 521, 554, 502, and 530 may also each include their own database. The repository 504 serves data from a database, which is a repository for data used by server 502 and devices 521, 554, and 530 during the course of operation of the disclosed embodiments. Database 504 may be distributed over one or more nodes or locations that are connected via network 506.

The database 504 may include a user record for a user or consumer 511 or 544. A user record may include one or more of: contact/identifying information for the user (name, address, telephone number(s), email address, etc.), information pertaining to credits associated with the user, contact/identifying information for friends of the user, electronic payment information for the user, information pertaining to the purchases made by the user, sales transaction data associated with the user, etc. A user record may also include one or more of a unique identifier for the user, a residential address for the user, the current location of the user (based on location-based services from the user's mobile computer) and a description of past goods/services purchased by the user. A user record may further include demographic data for the user, such as age, sex, income data, race, color, marital status, etc. A user record may also include contact information (email address, name, address, telephone number, etc.) or a unique identifier for one or more friends or acquaintances of the user. A user record may also include a user credit, which is a credit that is used by a consumer while using an application, such as while using a video game during gameplay. Said credit can be used to purchase or receive virtual goods, real goods, virtual services, real services, etc. Credit refers to any medium of exchange, which can include digital currency, purchase cards, gift cards, player credits, points, etc. Credit may also refer to features, functionality or a virtual good itself, such as a skin, an avatar, a virtual good, etc. Note the consumer 544 may be the recipient of a credit, not just the consumer 511.

Sales transaction data may include one or more product/service identifiers (such as SKUs), one or more product/service amounts, buyer contact/identifying information, brick and mortar outlet information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 504 may include a record for each offer. An offer may include one or more application features corresponding to an application service, wherein each application feature has feature enablement criteria. An application feature may be a credit, a gameplay feature, increased or enhanced health, abilities, powers or skills, a skin, a weapon, an avatar, unlocking levels, game currency, or the like. An offer may also include one or more user qualification criteria, one or more offer items, or one or more offer locations. Feature enablement criteria may comprise one or more of a purchase amount, a purchase of at least one of the one or more offer items, or an indication that a client device is located in proximity to at least one of the one or more offer locations.

FIG. 5 shows an embodiment wherein networked computing devices 521, 554, 530, and 590 interact with server 502 and repository 504 over the network 506. It should be noted that although FIG. 5 shows only the networked computers 521, 554, 530, 590, and 502, the system of the disclosed embodiments supports any number of networked computing devices connected via network 506. Further, server 502, and units 521, 554, 530, and 590 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 502 is shown as a single and independent entity, in one embodiment, the functions of server 502 may be integrated with another entity, such as one of the devices 521, 554, 530, and 590. Further, server 502 and its functionality, in some aspects, can be realized in a centralized fashion in one computer system or in a distributed fashion wherein different elements are spread across several interconnected computer systems.

FIG. 5 also shows a payment authority 590, which acts to effectuate payments by consumer 511 or consumer 544 for credits provided to consumer 511 or consumer 544, or the like. In the course of a sales transaction, server 502, retailer 550 or retailer server 530 may interface with payment authority 590 to effectuate payment. In one embodiment, the payment authority 590 is a payment gateway, which is an e-commerce Application Service Provider (ASP) service that authorizes and processes payments from one party to another. The payment authority 590 may accept payment via the use of purchase cards, i.e., credit cards, charge cards, bank cards, gift cards, account cards, etc.

FIG. 5 also shows a retailer 550, which represents a retailer of goods or services engaged in commerce activities. The retailer 550 may be a retail store, a shop, a department store, a fast-food restaurant, an ecommerce store, a restaurant, a cafeteria, a music venue, a sports venue, a theater, an arena, a stage, an amphitheater, an outdoor concert structure, stadium, bandshell, bandstand, concert hall, opera house, nightclub, discotheque, park, bar, pub, sports complex, etc. The retailer 550 may be online, digital, virtual or brick and mortar, and the like. The retailer server 530 may represent the information technology infrastructure, including servers and computers, which are used by the retailer 550 to control and manage sales transaction data for retail sales of goods and services.

The consumer 511 or consumer 544 may enroll and register with server 502 and/or server 530. In the course of enrolling or registering, the users may enter data into their device by manually or automatically entering data into a mobile application via keypad, touchpad, or via voice or other means. In the course of enrolling or registering, the users may enter any data that may be stored in a user record, as defined above. Also in the course of enrolling or registering, the server 502 and/or server 530 may generate a user record for each registering user and store the user record in an attached database, such as database 504.

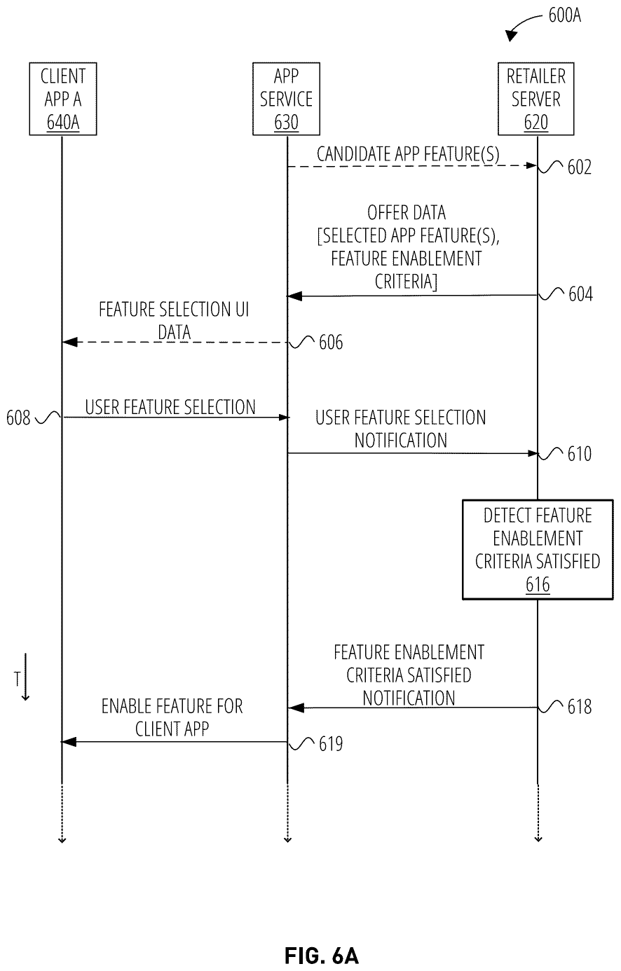

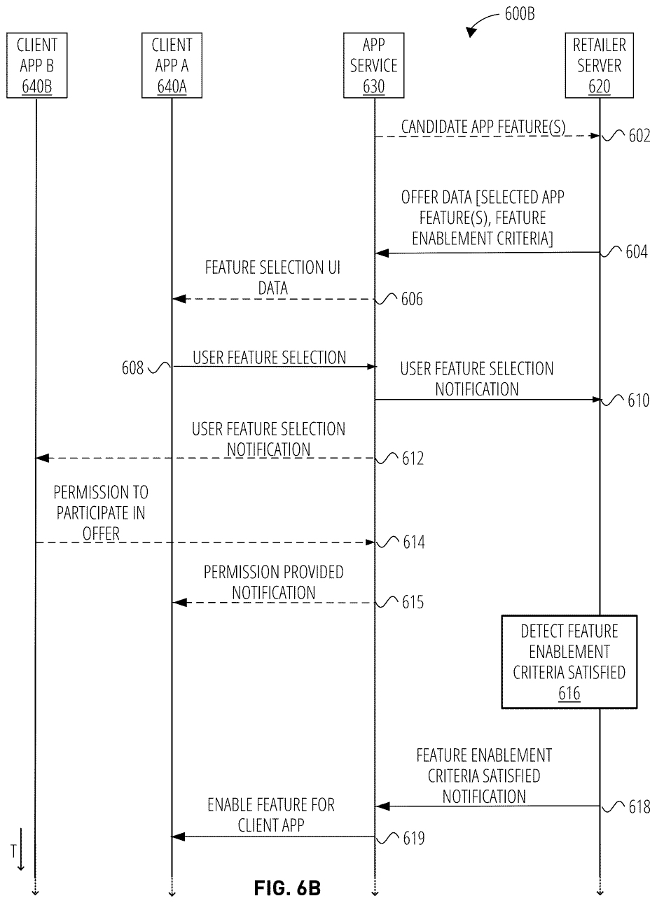

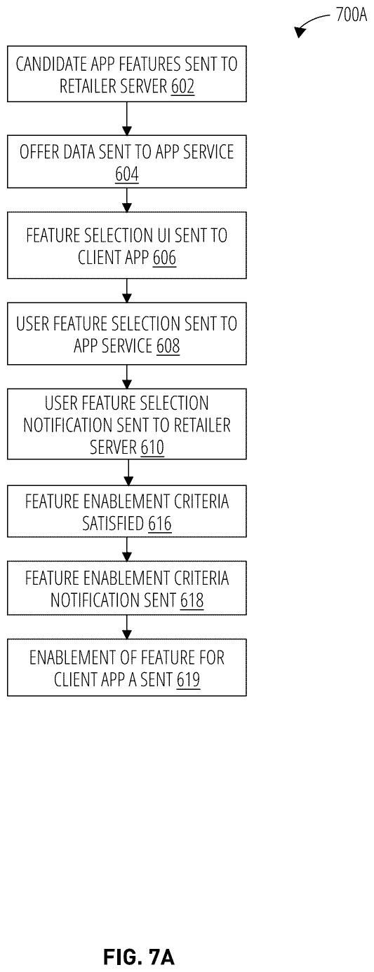

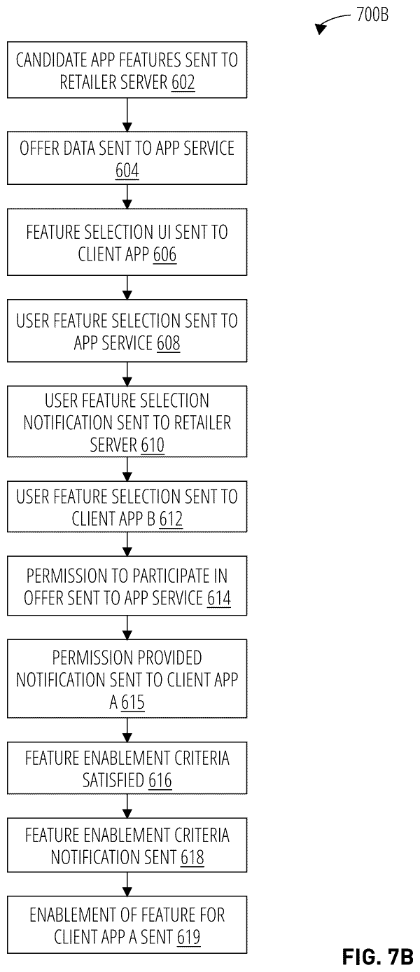

The process of increasing retail sales of goods and services over a communications network will now be described with reference to FIG. 6A, FIG. 6B, FIG. 7A and FIG. 7B below. FIG. 6A and FIG. 7A depict the data flow and control flow of the process for increasing retail sales of goods and services over a communications network 506 (FIG. 5), according to the first embodiment. FIG. 6B and FIG. 7B depict the data flow and control flow of the process for increasing retail sales of goods and services over a communications network 506, according to the second embodiment. Dotted lines in FIG. 6A and FIG. 6B indicate optional operations.

In the first embodiment of FIG. 6A and FIG. 7A, the communication flow 600A begins with an operation 602, wherein the application service 630 transmits to the retailer server 620, over the communications network 506, one or more candidate application features that may be used in the course increasing retail sales by presenting offers to consumers. The retailer server selects one or more of the one or more candidate application features to determine which candidate application features to include in the offers it will present to the consumers. At operation 604, the retailer server 620 transmits data that defines an offer to the application service. This data not only specifies one or more application features that are pertinent to the application service but also delineates feature enablement criteria for each application feature. This allows for dynamic interaction between the application service and the retailer's offerings, providing a tailored experience based on specific criteria met by the user or the environment.

Upon obtaining the offer data, at operation 606, the application service 630 transmits it to the client application A 640A, which offer data may be in the form of a feature selection user interface (UI) data. This data defines how the one or more application features in the offer is displayed on the client device 521 and/or 554. The consumer 511 and/or 544 then selects one or more application features from among the presented options. The selection process can also include the choice of an offer, demonstrating the system's flexibility in accommodating various user interactions and intents.

At operation 608 the client application A 640A transmits to the application service 630 the selection of one or more application features that was selected by the consumer 511 and/or 544. At operation 610, the application service 630 sends the selection of one or more application features in a notification to the retailer server 620. In one optional operation after operation 610, the retailer server transmits the selection of one or more application features in a notification to a client application. Thereafter, said client application responds to the retailer server with a qualifying purchase notification.

At block 616, the retailer server 620 detects that the feature enablement criteria for the selected application feature has been met. In one embodiment, to satisfy the criteria, the consumer 544 may have purchased a good or service from retailer 550 on her mobile computing device (via retailer server 530) or in person at a brick and mortar store of retailer 550.

At operation 618, the application service 630 receives a first indicator from the retailer server 620 or a retailer mobile application, signaling that the feature enablement criteria have been satisfied. This could involve a range of conditions such as achieving a certain purchase amount, purchasing specific offer items, or confirming the proximity of the first client device to designated offer locations. The data defining the offer may further comprise user qualification criteria, details of the offer items, or the offer locations, enriching the contextual framework within which the application features operate.

In response to the receipt of the first indicator, at operation 619, the application service 630 proceeds to provide a second indicator to the first client application A 640A. This second indicator confirms that the selected application feature is now enabled, enabling a direct and immediate acknowledgment of the user's fulfillment of the offer criteria.

The claimed embodiments extend their functionality to interactions with a second client application which may reside on the first or second client device. In the second embodiment of FIG. 6B and FIG. 7B, the process 600B begins with a first operation 602, the application service 630 transmits to the retailer server 620, over the communications network 506 (FIG. 1), one or more candidate application features that may be used in the course of increasing retail sales by presenting offers to consumers. The retailer server selects one or more of the one or more candidate application features to determine which candidate application features to include in the offers it will present to the consumers. At operation 604, the retailer server 620 transmits data that defines an offer to the application service.

Upon obtaining the offer data, at operation 606, the application service 630 transmits it to the first client application A 640A on the first client device, which offer data may be in the form of a feature selection user interface (UI) data. The user then selects one or more application features from among the presented options. At operation 608 the client application A 640A transmits to the application service 630 the selection of one or more application features that was selected by the consumer 511. At operation 610, the application service sends the selection of the one or more application features in a notification to the retailer server 620. At operation 612, the application service 630 transmits to the second client application B 640B on the first or second client computing device the application features that were selected by the consumer 511. The data sent to the client application B encompasses a variety of identifiers and indicators including, but not limited to, a first identifier for the selected application feature(s), a third indicator for the feature enablement criteria for the selected application feature(s), and identifiers for both the first client application and device.

At operation 614, the second client application B 640B transmits to the application service 630 a permission to participate in the offer. The data sent to the application service may include a fourth indicator from the second client application, indicating permission to participate in the offer. In one optional operation after operation 614, at operation 615, the client application B 640B transmits a qualifying purchase notification to the retailer server.

At operation 616, the retailer server 620 detects that the feature enablement criteria for the selected application feature(s) have been met. At operation 618, the application service 630 receives a first indicator from the retailer server 620 or a retailer mobile application, signaling that the feature enablement criteria have been satisfied. In response to the receipt of the first indicator, at operation 619, the application service 630 proceeds to provide a second indicator to the first client application A 640A. This second indicator confirms that the selected application feature is now enabled, enabling a direct and immediate acknowledgment of the user's fulfillment of the offer criteria.

The scope of the claimed embodiments also incorporates scenarios where the first and second client devices are the same, illustrating the system's adaptability to different user configurations and preferences. Moreover, the application service may include a first client application program interface (API) configured to receive the data defining the offer and a second API to receive the first indicator, emphasizing the technical infrastructure that supports these complex interactions. Furthermore, the application service is capable of providing program code to modify the user interface (UI) of the first client application. This enables the display of graphical elements corresponding to the application features, thereby enhancing the user experience by visually representing the opportunities and actions available to the user based on the retailer's offers.

Through its comprehensive approach to obtaining data, receiving selections and indicators, and facilitating interactions between multiple client applications and devices, the techniques of the disclosure offers a robust framework for enhancing user engagement and personalization in the context of retailer promotions and offers.

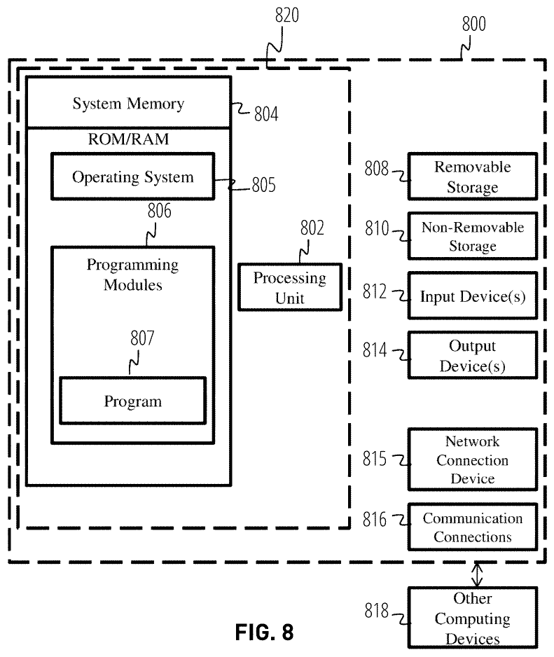

FIG. 8 is a block diagram of a system including an example computing device 800 and other computing devices. Consistent with the embodiments described herein, the aforementioned actions performed by devices 102, 104, 108, and 114 of FIG. 1 and devices 521, 554, 502, and 530 of FIG. 5 may be implemented in a computing device, such as the computing device 800 of FIG. 8. Any suitable combination of hardware, software, or firmware may be used to implement the computing device 800. The aforementioned system, device, and processors are examples and other systems, devices, and processors may comprise the aforementioned computing device. Furthermore, computing device 800 may comprise an operating environment for system 500 and processes 600A, 600B, as described above.

Processes 600A and 600B may operate in other environments and are not limited to computing device 800.

With reference to FIG. 8, a system consistent with an embodiment may include a plurality of computing devices, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination or memory. System memory 804 may include operating system 805, and one or more programming modules 806. Operating system 805, for example, may be suitable for controlling computing device 800′s operation. In one embodiment, programming modules 806 may include, for example, a program module 807 for executing the actions of devices 102, 104, 108, and 114 of FIG. 1 and devices 521, 554, 502, and 530 of FIG. 5. Furthermore, embodiments may be practiced in conjunction with a graphics library, other operating systems, or any other application program and is not limited to any particular application or system. This basic configuration is illustrated in FIG. 8 by those components within a dashed line 820.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 808 and a non-removable storage 810. Computer storage media may include volatile and nonvolatile, removable and non-removable media implemented in any method or technology for storage of information, such as computer readable instructions, data structures, program modules, or other data. System memory 804, removable storage 808, and non-removable storage 810 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of computing device 800.

Computing device 800 may also have input device(s) 812 such as a keyboard, a mouse, a pen, a sound input device, a camera, a touch input device, etc. Output device(s) 814 such as a display, speakers, a printer, etc. may also be included. Computing device 800 may also include a vibration device capable of initiating a vibration in the device on command, such as a mechanical vibrator or a vibrating alert motor. The aforementioned devices are only examples, and other devices may be added or substituted.

Computing device 800 may also contain a network connection device 815 that may allow computing device 800 to communicate with other computing devices 818, such as over a network in a distributed computing environment, for example, an intranet or the Internet.

Device 815 may be a wired or wireless network interface controller, a network interface card, a network interface device, a network adapter or a LAN adapter. Device 815 allows for a communication connection 816 for communicating with other computing devices 818.

Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 804, including operating system 805. While executing on processing unit 802, programming modules 806 (e.g. program module 807) may perform processes including, for example, one or more of the stages of the processes and flows 200A-200D, 300, 310, 320, 330, 400A, 400B, 600A, 600B, 700A, and 700B as described above. The aforementioned processes are examples, and processing unit 802 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist.

Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart, flow diagram or sequence diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Although the subject matter has been described in language specific to structural features and/or methodological acts, it is to be understood that the subject matter defined in the appended claims is not necessarily limited to the specific features or acts described above.

Rather, the specific features and acts described above are disclosed as example forms of implementing the claims.

The following additional considerations may apply to the foregoing and the following discussions.

Unless defined otherwise, technical and scientific terms used herein have the same meaning as is commonly understood by one of ordinary skill in the art to which this specification belongs. The terms “first,” “second,” and the like, as used herein do not denote any order, quantity, or importance, but rather are used to distinguish one element from another. The use of terms “including,” “comprising” or “having” and variations thereof herein are meant to encompass the items listed thereafter and equivalents thereof as well as additional items. The terms “connected” and “coupled” are not restricted to physical or mechanical connections or couplings and can include electrical connections or couplings, whether direct or indirect. Furthermore, terms “circuit” and “circuitry” and “control unit” may include either a single component or a plurality of components, which are either active and/or passive and are connected or otherwise coupled together to provide the described function. In addition, the term operationally coupled as used herein includes wired coupling, wireless coupling, electrical coupling, magnetic coupling, radio communication, software based communication, or combinations thereof.

Some or all of the foregoing or the following implementations can be jointly combined or formed to be a new or another one implementation. The foregoing or the following techniques can be used to solve at least (but not limited to) the issue(s) or scenario(s) mentioned in this disclosure. Any two or more than two of the foregoing or the following paragraphs, (sub)-bullets, points, actions, or claims described in each method/technique/implementation may be combined logically, reasonably, and properly to form a specific method. Any sentence, paragraph, (sub)-bullet, point, action, or claim described in each of the foregoing or the following technique(s)/implementation(s)/concept(s) may be implemented independently and separately to form a specific method. Dependency, such as “based on,” “more specifically,” “where” or etc., in technique(s)/implementation(s)/concept(s) mentioned in this disclosure is just one possible implementation which would not restrict the specific method.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE),” and vice versa. In some implementations, “IE” is used and can be replaced by “field,” and vice versa. In some implementations, “configuration” can be replaced by “configurations” or “configuration parameters,” and vice versa. In some implementations, “some” means “one or more.” In some implementations, “at least one” means “one or more.”

As used herein, the term “device” refers to any one or all of cellular telephones, smartphones, portable computing devices, personal or mobile multi-media players, laptop computers, tablet computers, smartbooks, Internet-of-Things (IOT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers, point-of-sale (POS) terminals, health monitoring devices, drones, cameras, media-streaming dongles or another personal media devices, wearable devices such as smartwatches, wireless hotspots, femtocells, broadband routers or other types of routers, and similar electronic devices which include a programmable processor and memory and circuitry configured to perform operations as described herein. Further, the user device may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain techniques are described in this disclosure as including logic or a number of components or modules. Modules can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

As used herein, the terms “component” and “module” are intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

As used herein, a phrase referring to a list of items separated by “or” refers to any combination of those items, including single members. For example, “a, b, or c” is intended to cover the possibilities of: a only, b only, c only, a combination of a and b, a combination of a and c, a combination of b and c, and a combination of a and b and c.

In this disclosure, an expression of “X/Y” may include meaning of any of the following: “X or Y” or “X and Y” or “X and/or Y.” An expression of “(A) B” or “B (A)” may include concept of “only B.” An expression of “(A) B” or “B (A)” may include the concept of “A+B” or “B+A.”

In this disclosure, the term “can” indicates a capability, or alternatively indicates a possible implementation option. The term “may” indicates a permission or a possible implementation option.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As described above, some aspects of the subject matter described in this specification can be implemented as software. For example, various functions of components disclosed herein, or various blocks or steps of a method, operation, process, communication flow, or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes.

1. An apparatus comprising:
one or more processors; and
an award provider service executed by the one or more processors of a server device, the award provider service configured to:
provide, via a network to a client application associated with a first enterprise and remote from the award provider service, data defining one or more game features corresponding to a game application associated with a second enterprise and executable remotely from the award provider service, the data including, for each of the one or more game features, feature enablement criteria including at least one of:
a mobile device hosting at least one of the game application or the client application is at a location of the first enterprise, or
the game application or the client application detects a qualifying interaction with the first enterprise,
receive, via the network from the at least one of the game application or the client application, a first indicator indicating that the at least one of the game application or the client application has automatically detected the feature enablement criteria corresponding to a game feature of the one or more game features has been satisfied, and
based on receipt of the first indicator, enable, via the network, for the game application, the game feature corresponding to the automatically detected feature enablement criteria.

2. The apparatus of claim 1, wherein to enable the game feature includes to provide, via the network to the game application, a second indicator indicating that the game feature is enabled.

3. The apparatus of claim 1, wherein to enable the game feature includes to provide, via the network to a game application service, a second indicator indicating that the game feature is enabled for the game application.

4. The apparatus of claim 1, wherein the award provider service is further configured to receive, from a game application service, second data indicating the one or more game features.

5. The apparatus of claim 1, wherein the data defining the one or more game features further includes one or more of user qualification criteria or at least one participating location of the first enterprise.

6. The apparatus of claim 1, wherein the qualifying interaction includes one or more of a purchase amount or a purchase of at least one item.

7. (canceled)

8. The apparatus of claim 1, wherein the client application includes a non-gaming application.

9. The apparatus of claim 1, wherein the client application is executed separately from the game application.

10. The apparatus of claim 1, wherein the award provider service is configured to provide, via the network to the client application, program code to modify a user interface (UI) of the client application to display one or more graphical elements corresponding to the one or more game features.

11. The apparatus of claim 1, wherein the award provider service is further configured to:
provide, via the network to the game application, an indicator of at least one of the one or more game features; and
receive, via the network from the client application, the indicator of the at least one of the one or more game features and an identifier associated with at least one of the game application or a device hosting the game application,
wherein to associate the game application with the client application includes to generate an association between the client application and the game application based, at least in part, on the identifier associated with the at least one of the game application or the device hosting the game application, and
wherein to enable the game feature includes to enable the game feature for the game application associated with the client application.

12. A device comprising:
one or more processors; and
a client application hosted on the device and executed by the one or more processors, the client application associated with a first enterprise, the client application configured to:
receive, via a network from an award provider service hosted on a server device and different from the device, data defining one or more game features corresponding to a game application associated with a second enterprise, the data including, for each of the one or more game features, feature enablement criteria, the feature enablement criteria including at least one of:
the device hosting the client application is at a location of the first enterprise,
the client application automatically detects a qualifying interaction with the first enterprise represented by the client application;
monitor for satisfaction of the feature enablement criteria;
automatically detect that the feature enablement criteria corresponding to the game feature has been satisfied; and
in response to the automatic detection that the feature enablement criteria corresponding to the game feature has been satisfied, communicate, via the network to the award provider service, a first indicator indicating that the feature enablement criteria has been satisfied to cause the award provider service to automatically enable via the network the game feature for the game application.

13. The device of claim 12, wherein the data defining the one or more game features further includes one or more of user qualification criteria or at least one participating location of the first enterprise.

14. The device of claim 12, wherein the qualifying interaction includes one or more of a purchase amount or a purchase of an item or items.

15. (canceled)

16. The device of claim 12, wherein the client application includes a non-gaming application.

17. The device of claim 12, wherein the client application and the game application are hosted on different devices.

18. The device of claim 20, wherein the client application is further configured to perform at least one of:
receive, from the game application, the second identifier;
receive, from the award provider service, the second identifier and an enrollment identifier, wherein the first enrollment request message includes at least the enrollment identifier, the first identifier, and the second identifier; or
receive, from the award provider service, the enrollment identifier, wherein the second enrollment request message includes the enrollment identifier and the first identifier.

19. The device of claim 18, wherein the client application configured to receive the second identifier includes the client application configured to perform at least one of:
obtain an image from the device hosting the game application and decode the second identifier associated with the game application based on the image;
receive the second identifier via a communication from the device hosting the game application, wherein the second identifier is associated with the game application or the device hosting the game application; or
receive the second identifier associated with the game application via a user input.

20. The device of claim 12, wherein the client application is further configured to perform at least one of:
communicate, via the network to the award provider service, a first enrollment request message including at least a first identifier associated with the client application and a second identifier associated with the game application, or
communicate, to the game application, a second enrollment request message including the first identifier associated with the client application; or
communicate, via the network to the award provider service, first identifying information associated with at least one of the client application or the device hosting the client application.

21. The device of claim 20,
wherein the first identifier includes at least one of a first device identifier of the device hosting the client application, a first application identifier of the client application, or a first account identifier associated with a first user of the client application; and
wherein the second identifier includes at least one of a second device identifier of a device hosting the game application, a second application identifier of the game application, or a second account identifier associated with a second user of the game application.

22. The apparatus of claim 1, wherein the award provider service is further configured to:
receive identifying information from at least one of the game application or the client application; and
associate the game application with the client application based on the identifying information.
